(19) United States
(12) Patent Application Publication
(10) Pub. No.: US 2021/0221973 A1
(43) Pub. Date: Jul. 22, 2021

(54) Foamed Thermoplastic Vulcanizate and Methods Related Thereto

(71) Applicant: Exxonmobil Chemical Company - Law Technology, Baytown, TX (US)

(72) Inventors: Wanli Wang, Shanghai (CN); Lina Ma, Shanghai (CN); Leander M. Kenens, Vlaams Brabant (BE); Toshiaki Yamaguchi, Yokohama, Kanagawa (JP); Michael W. Bednarik, Fairlawn, OH (US); Guan Wei Zhou, Shanghai (CN)

(21) Appl. No.: 16/972,108

(22) PCT Filed: May 29, 2019
(86) PCT No.: PCT/US2019/034263

§ 371 Date: Dec. 4, 2020

Related U.S. Application Data
(60) Provisional application No. 62/682,388, filed on Jun. 8, 2018.

(51) Int. Cl. C08J 9/32; C08J 9/36

(52) U.S. Cl. CPC C08J 9/32; C08J 9/365; C08J 2323/16; C08J 2201/026; C08J 2307/00; C08J 2203/22; C08J 2201/03; C08J 2309/00

(57) ABSTRACT

Foamed thermoplastic vulcanizate compositions having minimal water absorption, and in particular having predominantly closed cell structure. The foam compositions exhibit desirable properties including, but not limited to, low density, tensile strength, ultimate elongation, and low modulus of elasticity. The foam may be used in one or more commercial products or articles, such as use in forming weather seals.

### CROSS-REFERENCE OF RELATED APPLICATION

This application claims the benefit of Provisional Application No. 62/682,388, filed Jun. 8, 2018, the disclosure of which is incorporated herein by reference.

### FIELD

This application relates to foamed thermoplastic vulcanizate compositions having minimal water absorption, and in particular having predominantly closed cell structure.

### BACKGROUND

Thermoplastic elastomers (or TPE) are materials that are both elastomeric and thermoplastic, yet are distinguished from thermoset rubbers, which are elastomeric but not thermoplastic due to the cross-linking or vulcanization of the rubber, and are distinguished from general thermoplastics which are generally stiff and hard, but not elastomeric.

Thermoplastic vulcanizate (TPV) is a class of TPE where cross-linked rubber forms a dispersed, particulate, elastomeric phase within a stiff thermoplastic phase, such that TPE properties are achieved. TPVs and TPV compositions are conventionally produced by dynamic vulcanization. Dynamic vulcanization is a process whereby a rubber component is crosslinked, or vulcanized, under intensive shear and mixing conditions within a blend of at least one non-vulcanizing thermoplastic polymer component while at or above the melting point of the thermoplastic polymer component. Typically, then the rubber component forms cross-linked, elastomeric particles dispersed uniformly throughout the thermoplastic. Dynamically vulcanized thermoplastic elastomers consequently have a combination of both thermoplastic and elastic properties and conventional plastic processing equipment can extrude, inject, or otherwise mold, and thus press and shape TPV compositions, into useful products alone or in composite structures with other materials. That is, TPV and TPV compositions possess the elasticity of conventional elastomers and the processability of thermoplastics, which makes TPVs attractive for a large number of applications, such as in automotive, industrial, and consumer market segments.

TPV can be used as a foaming material by incorporating a modifier or filler or other components. Endothermic and exothermic chemical or physical foaming agents are blended to the thermoplastic base material. For example, WO 2004/016679A2 describes soft thermoplastic vulcanizate foams comprising a polyolefin thermoplastic resin, an at least partially crosslinked olefinic elastomer, a hydrogenated styrenic block copolymer, and optional additives. The soft foams have smooth surfaces, relatively low water absorption, and improved compression set and compression load deflection. WO2007/0044123A1 describes a thermoplastic vulcanizate that can be foamed by employing supercritical foaming methods, including at least one cured rubber component, at least one conventional thermoplastic resin, at least one random polypropylene copolymer, and at least one thermoplastic elastomer styrenic block copolymer.

Though the above-mentioned methods can provide a foamed/expanded material, they may be inadequate for certain sealing applications, such as weather seal applications. For example, they may result in an inhomogeneous structure that fails to exhibit properties necessary for maintaining adequate sealing, such as low water absorption that may be achieved by low-density compositions having closed cell structure (which may interchangeably be referred to herein as “close cell structure”). That is, typical TPV and TPV compositions using traditional foaming agents may have relatively high density and open cell structure, which fail to meet the high-level requirements in automotive, industrial, or consumer markets for effective sealing.

### SUMMARY OF THE INVENTION

The present disclosure provides a foam composition exhibiting desirable closed cell structure, having a low density and, accordingly, low water absorption. The foam further exhibits desirable properties including, but not limited to, tensile strength, ultimate elongation, and low modulus of elasticity. The foam may be used in one or more commercial products, including various seals, such as weather seals.

In one or more aspects, the present disclosure provides a foam comprising a thermoplastic vulcanizate including an at least partially vulcanized rubber component and a thermoplastic component having a density of 0.4 grams per cubic centimeter (g/cm³) to 0.9 g/cm³ and a water absorption of less than 5% at a pressure of 172 millibar (mbar) below atmosphere.

In one or more aspects, the present disclosure provides a method of forming a foam comprising a thermoplastic vulcanizate including an at least partially vulcanized rubber component and a thermoplastic component having a density of 0.4 g/cm³ to 0.9 g/cm³ and a water absorption of less than 5% at a pressure of 172 mbar below atmosphere. The method includes blending the thermoplastic vulcanizate with a thereto-expandable microsphere foaming agent and extruding the blended thermoplastic vulcanizate and the thereto-expandable microsphere foaming agent at an extrusion temperature to form the foam.

In one or more aspects, the present disclosure provides a seal, such as a weather seal, composed of a foam comprising a thermoplastic vulcanizate including an at least partially vulcanized rubber component and a thermoplastic component having a density of 0.4 g/cm³ to 0.9 g/cm³ and a water absorption of less than 5% at a pressure of 172 mbar below atmosphere.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 shows a chart of extensional viscosity for various commercially available TPV compositions.

### DETAILED DESCRIPTION

The present disclosure provides a foam composition exhibiting desirable closed cell structure, having a low density and, accordingly, low water absorption. The foam further exhibits desirable properties including, but not limited to, tensile strength, ultimate elongation, and low modulus of elasticity. The foam may be used in one or more commercial products, including various seals, such as weather seals.

As an example of industry sealing requirements, traditional weather seals are composed of a TPV or an ethylene-propylene-diene (EPDM) rubber foamed with one or more traditional foaming agents, such as chemical, supercritical, or water. Such compositions generally result in relatively high water absorption indicative of open cell structure, which provides adequate but not optimal sealing qualities. It is desirable to reduce water absorption for such weather seals where absorbed water (e.g., due to environmental conditions such as rain, ice, snow, and the like) may, for example, alter the force required to create the seal, reduce flexibility of the seal, and/or cause adherence of other materials (e.g., an automotive door seal having frozen absorbed water causing the door to stick to the seal). While coating layers have been traditionally employed to reduce water absorption in producing such seals, it is desirable that the seal itself (i.e., the underlying composition of the seal) exhibit low water absorption.

One or more illustrative embodiments incorporating the embodiments of the present disclosure are included and presented herein. Not all features of a physical implementation are necessarily described or shown in this application for the sake of clarity. It is understood that in the development of a physical embodiment incorporating the embodiments of the present disclosure, numerous implementation-specific decisions must be made to achieve the developer's goals, such as compliance with system-related, business-related, government-related, and other constraints, which vary by implementation and from time to time. While a developer's efforts might be time-consuming, such efforts would be, nevertheless, a routine undertaking for those of ordinary skill in the art and having benefit of this disclosure.

Unless otherwise indicated, all numbers expressing quantities of ingredients, properties such as physical properties, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques. Where the term “less than about” or “more than about” is used herein, the quantity being modified includes said quantity, thereby encompassing values “equal to.” That is “less than about 3.5%” includes the value 3.5%, as used herein.

While compositions and methods are described herein in terms of “comprising” various components or steps, the compositions and methods can also “consist essentially of” or “consist of” the various components and steps.

Various terms as used herein are defined below. To the extent a term used in a claim is not defined below, it should be given the broadest definition persons in the pertinent art have given that term as reflected in one or more printed publications or issued patents.

The terms “foam” or “foam composition,” and grammatical variants thereof, as used herein, refers to a durable structure having a density of less than 0.9 grams per cubic centimeter (g/cm³) and having a primarily closed cell content (greater than at least 50%, and in some embodiments greater than at least 80% or 90%).

The term “thermoplastic vulcanizate,” and grammatical variants thereof, including “thermoplastic vulcanizate composition,” “thermoplastic vulcanizate material,” or “TPV,” and the like, is broadly defined as any material that includes a dispersed, at least partially vulcanized, rubber component and a thermoplastic component (e.g., a polyolefinic thermoplastic resin). A TPV material can further include other ingredients, other additives, or combinations thereof. Examples of commercially available TPV material include SANTOPRENE™ thermoplastic vulcanizates available from ExxonMobil Chemical, Houston, Tex.

The thermoplastic vulcanizate of the present disclosure may have a melt temperature (i.e., the temperature at which the thermoplastic vulcanizate components change state from solid to liquid at atmospheric pressure) in the range of about 100° C. to about 300° C., encompassing any value and subset therebetween. In preferred embodiments, the melt temperature is in the range of about 160° C. to about 240° C., or about 170° C. to about 200° C., encompassing any value and subset therebetween. The thermoplastic vulcanizate may have a Shore A hardness as determined by ISO868:2003 in the range of about 25 to about 100, encompassing any value and subset therebetween. For example, in some embodiments, the TPV for use in the foam of the present disclosure has a Shore A hardness in the range of about 35 to about 87, encompassing any value and subset therebetween.

The term “vulcanizate,” and grammatical variants thereof, means a composition that includes some component (e.g., rubber) that has been vulcanized. The term “vulcanized,” and grammatical variants thereof, is defined herein in its broadest sense, as reflected in any issued patent, printed publication, or dictionary, and refers in general to the state of a composition after all or a portion of the composition (e.g., a crosslinkable rubber) has been subjected to some degree or amount of vulcanization. Accordingly, the term encompasses both partial and total vulcanization. A preferred type of vulcanization is “dynamic vulcanization,” discussed below, which also produces a “vulcanizate.” Also, in at least one specific embodiment, the term vulcanized refers to more than insubstantial vulcanization (e.g., curing (or crosslinking)) that results in a measurable change in pertinent properties (e.g., a change in the melt flow index (MFI) of the composition by 10% or more, according to any ASTM-1238 procedure). In at least one or more contexts, the term vulcanization encompasses any form of curing (or crosslinking), both thermal and chemical, that can be utilized in dynamic vulcanization.

The term “dynamic vulcanization,” and grammatical variants thereof, means vulcanization or curing of a curable rubber component blended with a thermoplastic component under conditions of shear at temperatures sufficient to plasticize the mixture. In at least one embodiment, the rubber component is simultaneously crosslinked and dispersed as micro-sized particles within the thermoplastic component. Depending on the degree of cure, the rubber component to thermoplastic component ratio, compatibility of the rubber component and thermoplastic component, the kneader type and the intensity of mixing (shear rate), other morphologies, such as co-continuous rubber phases in the plastic matrix, are possible.

The term “partially vulcanized,” and grammatical variants thereof (e.g., “at least partially vulcanized”), with reference to a rubber component is one wherein more than 5 weight percent (wt. %) of the rubber component (e.g., crosslinkable rubber component) is extractable in boiling xylene, subsequent to vulcanization, preferably dynamic vulcanization (e.g., crosslinking of the rubber phase of the thermoplastic vulcanizate). For example, at least 5 wt. % and less than 20 wt. % or 30 wt. % or 50 wt. % of the rubber component can be extractable from the specimen of the thermoplastic vulcanizate in boiling xylene, encompassing any value and subset therebetween. The percentage of extractable rubber component can be determined by the technique set forth in U.S. Pat. No. 4,311,628, which is hereby incorporated by reference in its entirety.

The rubber component of the thermoplastic vulcanizates described herein may be any material that is considered by persons skilled in the art to be a “rubber,” preferably a crosslinkable rubber component (e.g., prior to vulcanization) or crosslinked rubber component (e.g., after vulcanization). For example, the rubber component may be any olefin-containing rubber including, but not limited to, ethylene-propylene copolymers (EPM), including particularly saturated compounds that can be vulcanized using free radical generators such as organic peroxides, as described in U.S. Pat. No. 5,177,147. Other rubber components may include, but are not limited to, EPDM rubber or EPDM-type rubber, for example, an EPDM-type rubber can be a terpolymer derived from the polymerization of at least two different monoolefin monomers having from 2 to 10 carbon atoms, preferably 2 to 4 carbon atoms, and at least one poly-unsaturated olefin having from 5 to 20 carbon atoms, encompassing any value and subset therebetween. Additional examples of suitable rubber components are described hereinbelow.

The rubber component may also be a butyl rubber. The term “butyl rubber,” and grammatical variants thereof, includes a polymer that predominantly includes repeat units from isobutylene but also includes a few repeat units of a monomer that provides a site for crosslinking. Monomers providing sites for crosslinking may include, but are not limited to, a polyunsaturated monomer, such as a conjugated diene or divinylbenzene. In one or more embodiments, the butyl rubber polymer may be halogenated to further enhance reactivity in crosslinking, which are referred to herein as “halobutyl rubbers.”

Further, the rubber component may be homopolymers of conjugated dienes having from 4 to 8 carbon atoms and rubber copolymers having at least 50 weight percent repeat units from at least one conjugated diene having from 4 to 8 carbon atoms, encompassing any value and subset therebetween.

The rubber component may also be synthetic rubber, which can be nonpolar or polar depending on the comonomers. Examples of synthetic rubbers include, but are not limited to, synthetic polyisoprene, polybutadiene rubber, styrene-butadiene rubber, butadiene-acrylonitrile rubber, and the like. Amine-functionalized, carboxy-functionalized, or epoxy-functionalized synthetic rubbers can also be used, examples including, but not limited to, maleated EPDM.

Suitable preferred rubber components include, but are not limited to, an ethylene-propylene rubber; an ethylene-propylene-diene rubber; a natural rubber; a butyl rubber; a halobutyl rubber; a halogenated rubber copolymer of p-alkystyrene and at least one isomonoolefin having 4 to 7 carbon atoms; a copolymer of isobutylene and divinyl-benzene; a rubber homopolymer of a conjugated diene having from 4 to 8 carbon atoms; a rubber copolymer having at least 50 weight percent repeat units from at least one conjugated diene having from 4 to 8 carbon atoms and a vinyl aromatic monomer having from 8 to 12 carbon atoms, or acrylonitrile monomer, or an alkyl substituted acrylonitrile monomer having from 3 to 8 carbon atoms, or an unsaturated carboxylic acid monomer, or an unsaturated anhydride of a dicarboxylic acid; or any combination thereof.

In one or more embodiments, the rubber component is present in the amount of from about 5wt. % by weight to about 85 wt. % of the total weight of the combined rubber component and thermoplastic component of the present disclosure, encompassing any value and subset therebetween. In one or more embodiments, the rubber component is present in the amount of less than 70 wt. %, or less than 50 wt. % of total weight of rubber component and thermoplastic component.

As used herein, the “thermoplastic component,” and grammatical variants thereof, of the thermoplastic vulcanizates of the present disclosure refers to any material that is not a “rubber” and that is a polymer or polymer blend considered by persons skilled in the art as being thermoplastic in nature (e.g., a polymer that softens when exposed to heat and returns to its original condition when cooled to room temperature). The thermoplastic component may comprise one or more polyolefins, including polyolefin homopolymers and polyolefin copolymers. In one or more embodiments, the polyolefinic thermoplastic component comprises at least one of i) a polymer prepared from olefin monomers having 2 to 7 carbon atoms and/or ii) copolymer prepared from olefin monomers having 2 to 7 carbon atoms with a (meth)acrylate or a vinyl acetate. Illustrative polyolefins can be prepared from mono-olefin monomers including, but not limited to, ethylene, propylene, 1-butene, isobutylene, 1-pentene, 1-hexene, 1-octene, 3-methyl-1-pentene, 4-methyl-1-pentene, 5-methyl-1-hexene, mixtures thereof and copolymers thereof with (meth)acrylates and/or vinyl acetates. In one or more preferred embodiments, the polyolefin thermoplastic component comprises polyethylene, polypropylene, ethylene-propylene copolymer, and any combination thereof. Preferably, the thermoplastic component is not vulcanized or not cross-linked.

In one or more embodiments, the thermoplastic component contains polypropylene. As used herein, the term “polypropylene,” and grammatical variants thereof, broadly means any polymer that is considered a “polypropylene” by persons skilled in the an (as reflected in at least one patent or publication), and includes, but is not limited to, homo, impact, and random polymers of propylene. In one or more embodiments, the thermoplastic component is or includes isotactic polypropylene. Preferably, the thermoplastic component contains one or more crystalline propylene homopolymers or copolymers of propylene having a melting temperature greater than 105° C. as measured by differential scanning calorimetry (DSC). Preferred copolymers of propylene include, but are not limited to, terpolymers of propylene, impact copolymers of propylene, random polypropylene copolymers, and any combination thereof. Preferred comonomers have 2 carbon atoms, or from 4 to 12 carbon atoms. Preferably, the comonomer is ethylene. Such thermoplastic components and methods for making the same are described in U.S. Pat. No. 6,342,565, which is incorporated herein by reference in its entirety.

As used herein and except as stated otherwise, the term “copolymer,” and grammatical variants thereof, refers to a polymer derived from two or more monomers (e.g., terpolymers, tetrapolymers, and the like).

In one or more embodiments, additives may be added into the thermoplastic vulcanizates. The term “additive,” and grammatical variants thereof, includes any component of the thermoplastic vulcanizates of the present disclosure except the rubber component, the thermoplastic component, and any thermo-expandable microsphere component. Examples of suitable additives include, but are not limited to, additive oils, curatives, particulate fillers, thermoplastic modifiers (e.g., elastomers such as VISTAMAXX™ polymers, available from ExxonMobil Chemical, Houston, Tex.), lubricants, antioxidants, antiblocking agents, stabilizers, anti-degradants, anti-static agents, waxes, foaming agents, pigments, processing aids, adhesives, tackifiers, plasticizers, wax, discontinuous fibers (such as world cellulose fibers), and any combination thereof.

In one or more embodiments, one or more additive oils may be included in the thermoplastic vulcanizates. The term “additive oil,” and grammatical variants thereof, encompasses both “process oils” and “extender oils.” For example, “additive oil” can include hydrocarbon oils and plasticizers, such as organic esters and synthetic plasticizers. The ordinarily skilled chemist will recognize which type of additive oil should be used with a particular rubber component type, and also be able to determine the suitable amount of oil, provided that the addition of an additive oil(s) shall not influence the foam ability of composition, as described herein.

As used herein, the term “curative,” and grammatical variants thereof, refers to any substance that is capable of curing or crosslinking the rubber component of the present disclosure. Illustrative curatives include, but are not limited to, phenolic resins, peroxides, maleimides, and silicon-containing curatives. Depending on the rubber component employed, certain curatives may be preferred; for example, where elastomeric copolymers containing units derived from vinyl norbornene are employed, a peroxide curative may be preferred because the required quantity of peroxide will not have a deleterious impact on the engineering properties of the thermoplastic component of the thermoplastic vulcanizate. In one or more other embodiments, it may be preferred not to employ peroxide curatives because they can, at certain levels, degrade the thermoplastic component of the thermoplastic vulcanizate.

A “particular filler,” and grammatical variants thereof, may be included in the thermoplastic vulcanizate foams of the present disclosure to enhance various properties thereof, such as strength; toughness; resistance to tearing, abrasion and flex fatigue; increase durability; alter color (i.e., act as a pigment); and the like. Illustrative particulate fillers include, but are not limited to, carbon black, silica, titanium dioxide, calcium carbonate, colored pigments, clay, and any combination thereof. When non-black fillers are used, it may be desirable to include a coupling agent to compatibilize the interface between the non-black fillers and polymers in the foam composition. The ordinarily skilled chemist will recognize which type of additives can be used based upon the property requirements, and also be able to determine the amount of additives, provided that the addition of a particular filler(s) shall not influence the foam ability of composition, as described herein.

The thermoplastic vulcanizate suitable to the composition according to the present disclosure can have various melt flow rates (MFR, determined by, for example, by ASTM D-1238 Condition L). In some embodiments, the TPV has a high MFR, whereas in other embodiments, the TPV may have a low MFR. Generally, it is preferred that the TPV have a relatively high MFR in order to enhance the foam quality of the compositions described herein.

In one or more embodiments, the thermoplastic component is present in the amount of from about 15 wt. % to about 95 wt. % based upon the total weight of the combined rubber component and thermoplastic component, encompassing any value and subset therebetween. In one or more embodiments, the thermoplastic component is present in the amount of more than 30 wt. % or more than 50 wt. % based upon the total weight of rubber component and thermoplastic resin component. In one or more embodiments, the amount of the thermoplastic component in the TPV foam composition according to the present invention is at least greater than about 80 wt. %, or about 85 wt. %, or about 90 wt. %, or about 95 wt. %, based on the total weight of the composition, encompassing any value and subset therebetween.

Any process for making TPVs may be employed for forming the foam compositions of the present disclosure and as described herein. For example, the individual materials and components, such as the one or more rubber component(s), thermoplastic component(s), and any additional additives, can be mixed at a temperature above the melting temperature of the thermoplastic component(s) to form a melt. Illustrative mixing equipment may include, but is not limited to, extruders with kneaders or mixing elements with one or more mixing tips or flights, extruders with one or more screws, and extruders of co- or counter-rotating type. Suitable mixing equipment may include, for example, BRABENDER™ mixers, BANBURY™ mixers, BUSS™ mixers and kneaders, and FARREL™ continuous mixers. One or more of those mixing equipment, including extruders, can be used in series, without departing from the scope of the present disclosure. Additional details for making a TPV is described in U.S. Pat. No. 4,594,390, which is hereby incorporated by reference in its entirety. In preferred embodiments, the TPV foam described herein is processed by extrusion.

As used herein, the terms “thermo-expandable microsphere” and “thermo-expandable microsphere foaming agent,” and grammatical variants thereof, refers to a TPV foaming agent having a polymer shell (e.g., a thermoplastic shell) encapsulating a propellant. When heated, the thermo-expandable microspheres expand, such as up to about 80 times their original volume. Descriptions of suitable thermo-expandable microspheres are included in U.S. Pat. Nos. 6,582,633 and 3,615,972, WO 1999046320, and WO 1999043758, which are hereby incorporated by reference in their entirety. Examples of commercially available thermo-expandable microspheres include, for example, EXPANCEL™ products, available from Akzo Nobel N.V, Amsterdam, Netherlands.

A thermo-expandable microsphere (also referred to herein simply as “microsphere(s)”) in the foam composition according to the present disclosure acts as a foaming agent, comprising a polymer shell encapsulating a propellant. In the microsphere, the polymer shell is generally a thermoplastic and may be made of a homo- or co-polymer of ethylenically unsaturated monomers, such as nitrile-containing monomer(s); the propellant is generally a liquid (e.g., a hydrocarbon) having a boiling temperature not higher than the softening temperature of the polymer shell. The expansion of the thermoplastic microspheres is governed entirely by physics. As the propellant is heated, the propellant evaporates and increases the intrinsic pressure, and at the same time, the shell softens due to exposure to the heat, thus causing the microsphere to expand. Generally, the microspheres may expand from about 2 to about 8 times their initial (non-heated) diameter or about 30 to about 80 times volume, and the thickness of polymer shell decreases to about 0.1 μm or less, encompassing any value and subset therebetween. The factors determining the expandability of the microspheres include the volatility of the encapsulated propellant, the gas permeability of the heated propellant, and the viscoelasticity of the polymer shell.

Various monomers are suitable for preparation of the polymer shell and may include, but are not limited to, acrylonitrile, methacrylonitrile, α-haloacrylonitrile, α-ethoxyacrylonitrile, fumarc nitrite, an acrylic ester, and any combination thereof. In a preferred embodiment, the polymer shell comprises polyacrylonitrile. The polymer shell generally has an expansion temperature (i.e., the glass transition temperature (Tg)) of from about 80° C. to about 200° C. depending on the composition of the polymer shell, encompassing any value and subset therebetween.

The liquids suitable for preparation of the propellant of the thermo-expandable microsphere usually have a boiling point lower than the softening temperature of the polymer shell at atmosphere pressure. Suitable liquids may include, but are not limited to, isobutene; 2,3-dimethylbutane; 2-methylpentane; 3-methylpentane; n-hexane, cyclohexane, heptane, isooctane, and any combination thereof.

When a thermo-expandable microsphere of the present disclosure is heated, it begins to expand at a certain temperature. The temperature at which the expansion starts is called the “minimum expansion temperature” or “Tₛₜₐᵣₜ,” while the temperature at which expansion is complete (i.e., the maximum expansion) is called the “maximum expansion temperature” or “Tₘₐₓ.” The Tₛₜₐᵣₜ and Tₘₐₓ can be measured by thermomechanical analysis (TMA) of the thermal expansion quality of the microsphere. The thermo-expandable microsphere suitable for forming the foam composition of the present disclosure may have a Tₛₜₐᵣₜ of greater than about 100° C. preferably greater than about 110° C., or about 120° C., or about 130° C., or about 140° C., or about 160° C. encompassing any value and subset therebetween. The thermo-expandable microsphere suitable for firming the foam composition of the present disclosure may have a Tₘₐₓ of less than about 300° C., more preferably less than about 260° C., or about 240° C., or about 220° C., or about 210° C., encompassing any value and subset therebetween. That is, the range of Tₛₜₐᵣₜ to Tₘₐₓ may be about 100° C. to about 300° C., encompassing any value and subset therebetween. In preferred embodiments, the Tₘₐₓ temperature is in the range of about 160° C. to about 240° C., or about 170° C. to about 200° C., encompassing any value and subset therebetween.

In some embodiments, the thermoplastic vulcanizate(s) and the microsphere(s) are selected for inclusion in forming the foam composition of the present disclosure such that the melt temperature of the TPV and the Tₘₐₓ of the microspheres are similar. In so doing, the expansion of the microspheres can be reliably (including completely) achieved without breaking the outer polymer shell, thereby ensuring desired closed cell structure and low water absorption of the resulting foam composition. This similarity in melt temperature and Tₘₐₓ is an advantage recognized by the present disclosure. In some embodiments, the melt temperature and Tₘₐₓ are within about ±40° C. of one another, encompassing any value and subset therebetween. In other embodiments, the melt temperature and Tₘₐₓ are within ±30° C., or preferably ±20° C., ±10° C., ±5° C. or have identical melt and Tₘₐₓ temperatures, encompassing any value and subset therebetween. The temperature similarity of the selected material may further depend on the particular processing method and equipment used. For example, depending on equipment and shear heating behavior, selection of the particular temperature similarity may be more or less important to achieve the desired closed cell structure and low water absorption.

The thermo-expandable microspheres suitable for forming the foam composition of the present disclosure before expansion may have various average particle sizes. In some embodiments, the particle size of the microspheres before expansion may range from about 1 micrometer (μm) to about 500 μm, preferably from about 2 μm to about 300 μm, more preferably from about 4 μm to about 100 μm, and most preferably from about 5 μm to about 50 μm, encompassing any value and subset therebetween. The average particle size of the microspheres after expansion is generally about 2 to about 8 times their initial (non-heated) size, such as in the range of from about 2 μm to about 4000 μm, encompassing any value and subset therebetween. In some embodiments, the average particle size of the microspheres after expansion is preferably not less than about 50 μm or not less than about 80 μm, or more preferably not less than about 100 μm or not less than about 120 μm. Selection of a particular sized microsphere may be based on a number of factors, such as cost, surface appearance, and the final properties of the foam (e.g., foam quality). For example, if the microspheres are too small, a greater microsphere amount may be required to achieve the desired properties, which may increase costs. Alternatively, selection of too large microspheres may alter surface appearance compared to the same density of microspheres having relatively smaller sizes. In some embodiments, the microspheres after expansion are preferably in the range of about 20 μm to about 140 μm, or about 40 μm to about 120 μm, or about 60 μm to about 100 μm, or about 80 μm.

The production of thermo-expandable microspheres can be achieved by any method known to one of skill in the art, such as a method comprising a step of polymerizing the monomers in an aqueous suspension in the presence of a propellant. Examples of such methods are described in U.S. Pat. No. 3,615,972, WO 1999046320, and WO 1999043758, each of which is hereby incorporated by reference in their entirely,

The amount of the thereto-expandable microsphere in the composition according to the present disclosure ranges from 0.5 wt. % to about 5 wt. % by the total weight of the foam composition, encompassing any value and subset therebetween. This amount of microsphere in the foam composition allows the foam to achieve the desired foam quality, described hereinbelow, and the desired mechanical properties. In some embodiments, the thermo-expandable microsphere is preferably present in the foam compositions described herein in the range of from about 0.5 wt. % to about 2.5 wt. %, or about 1.5 wt. % to about 2.5 wt. %, encompassing any value and subset therebetween.

The physical expansion of a thermo-expandable microsphere results in a foam having a closed, and homogenous, cell structure, which provides low water absorption of the foamed composition according to the present disclosure.

In an aspect of the present disclosure, a foam composition comprising a thermoplastic vulcanizate including an at least partially vulcanized rubber component and a thermoplastic component is provided, the composition of which may be foamed using the thermo-expandable microsphere(s) described above. In another aspect, the present disclosure provides a method of preparing the foam composition including the steps of (i) blending the thermoplastic vulcanizate with the thermo-expandable microsphere foaming agent and (ii) extruding the blend at an extrusion temperature to form the foam.

The foam of present disclosure may be preferably prepared by extrusion moulding. As used herein, the term “extrusion moulding,” and grammatical variants thereof (e.g., “extrusion molding”), refers to any process performed by a component of an extruder, including blending (e.g., when no pre-blending is used), screw mixing, feeding through a die, and the like. The term “blending” encompasses any type of blending including, but not limited to, dry blending, melt blending, and hopper blending.

In an extrusion process, all ingredients can be pre-blended and fed into a hopper of an extruder. Alternatively, the ingredients may be blended using the extruder itself, such that each component is separately fed into the hopper. The shearing developed by the screw of the extruder will plasticize and mix the ingredients together. Accordingly, in any embodiments of the present disclosure, the ingredients may be blended by any method known to one of skill in the art, including dry blending, melt blending, hopper blending, or mixing by extruder. Pressure is built up against a die, and the blended ingredients are pushed out in a given shape. Within the hopper and/or outside of the die, the thereto-expandable microsphere may expand and create the foam structure when at a temperature between the Tₛₜₐᵣₜ and Tₘₐₓ values. The expansion process stops when the gas pressure inside the polymer shell becomes lower than the modulus of the polymer.

An extruder for use in preparing the foam compositions of the present disclosure may be any suitable instrument known in the art for monocomponent or multicomponent extrusion, such as for combining at least two up to five materials. In one or more embodiments, the extruder is a smooth barrel extruder or a grooved barrel extruder.

Generally, it is preferred that high shearing action is produced in the selected extruder for forming the foam composition of the present disclosure. The screw may be any suitable instrument known in the art, provided that it can produce appropriate shearing including, for example, a pin screw, a Maddock-type screw, or a barrier screw. In a preferred embodiment, the screw is a barrier screw or a Maddock-type screw. In some embodiments, the extruder has a ratio of length to diameter of more than about 20.

The preparation of the foam according to the present disclosure is independent from screw speed (revolutions per minute (RPM)) because the foaming of thereto-expandable microsphere is only a temperature dependent process, as described herein. The screw speed during the extrusion process may accordingly be either slow or fast, without affecting the foaming quality, such as in the range of about 5 RPM to about 100 RPM, encompassing any value and subset therebetween, provided that the selected speed does not compromise the integrity of the polymer shell of the thermo-expandable microsphere.

The blending and/or extrusion of the ingredients of the foam of the present disclosure in the extruder is generally performed at an extrusion temperature not exceeding about 400° C., preferably not exceeding about 300° C. and more particularly not exceeding about 250° C. The minimum extrusion temperature is generally higher than or equal to about 130° C., preferably higher than or equal to about 150° C. and more particularly higher than about 160° C.

In some embodiments, the extrusion temperature is selected such that it is within about ±40° C. of both the melt temperature of the TPV and the Tₘₐₓ of the thermo-expandable microsphere in the foam composition, encompassing any value and subset therebetween. For example, the extrusion temperature may be within ±30° C., or preferably ±20° C., ±10° C., ±5° C. or be identical to the melt and Tₘₐₓ temperatures, encompassing any value and subset therebetween. In some embodiments, the extrusion temperature is in the range of about 160° C. to about 240° C., or about 170° C. to about 200° C., encompassing any value and subset therebetween.

The foam prepared according to the present invention exhibits superior, low water absorption values, reduced density and hardness, and suitable physical properties suitable for soft touch applications, and more particularly for use in forming sealing products. As used herein, the terms “seal,” and grammatical variants thereof, refers to any substance that is able to join two materials together and prevent or reduce passage of other materials therebetween. A “sealing product,” and grammatical variants thereof, as used herein, refers to any commercial embodiment of a seal, encompassing all construction seals, such as industrial engineering seals, mechanical seals, automotive seals, and the like. In the embodiments of the present disclosure, the foam compositions of the present disclosure may be particularly well suited for sealing products that encounter harsh external (i.e., with respect to the seal) environments, including temperature variations, liquid surroundings, pressure fluctuations, and the like; a sealing product that encounter such environments are referred to herein as “weather seal,” and grammatical variants thereof, and may be any type of construction seal, without limitation. In some embodiments, the weather seal is an automotive seal, such as a door seal a window seal, or a trunk seal. Accordingly, the foam compositions of the present disclosure may be used for soft sealing purposes and formation of soft sealing products (e.g., soft touch applications), regardless of their final seal use.

In one or more embodiments, the foam compositions of the present disclosure having a TPV and thermo-expandable microsphere blend exhibit a water absorption of less than about 5% (including 0%) at a pressure of 172 millibar (mbar) below atmosphere, as determined by ASTM D1056, In some embodiments, the water absorption is in the range of about 0.01% mbar to about 5% mbar at a pressure of 172 mbar below atmosphere, such as less than about 0.01% to about 3.5%, or about 0.04% to about 3.5%, or less than about 3.5%, encompassing any value and subset therebetween. This low water absorption is observed as a result of inclusion of the microspheres, and indicates that the foam composition is closed cell in nature, thereby able to be used in forming various physical commercial products, such as the construction seals, including weather seals (e.g., door seals, window seals, trunk seals, and the like), described herein.

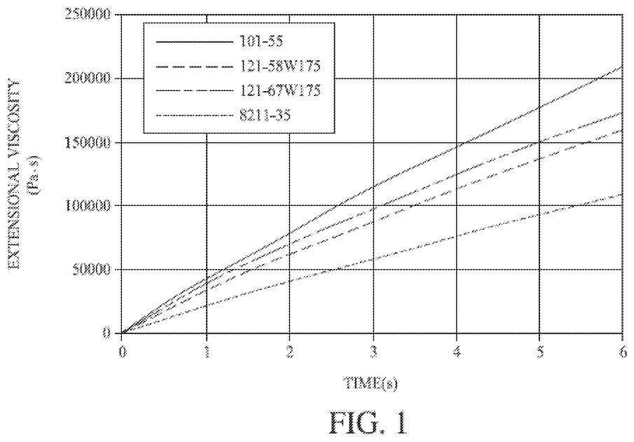

In one or more embodiments, the foam compositions described herein having a TPV and thermo-expandable microsphere blend exhibit an extensional viscosity as tested using ARES-G2 Rheometer by TA Instruments, New Castle, Del. The sample was compressed into a bar-shape at 190° C. for 2 minutes. The compressed bar was thereafter placed in the clamp of the Rheometer and pulled at a constant speed in the range of about 0.1 rad/second to about 100 rad/second at 190° C. and the viscosity was measured along the extension. As shown in FIG. 1, and further discussed hereinbelow, in some embodiments, the extensional viscosity may be in the range of about 200,000 Pa·s to about 75,000 Pa·s after 5 seconds of applied extensional stress of 0.1 rad/second and at a temperature of 190° C., such as in the range of about 150,000 Pa·s to about 75,000 Pa·s, or about 100,000 Pa. s to about 75,000 Pa·s, or about 75,000 Pa·s after 5 seconds of applied extensional stress of 0.1 rad/second and at a temperature of 190° C., encompassing any value and subset therebetween. It is to be understood that precise extensional viscosity of the foam compositions described herein may fluctuate depending on the precise equipment and testing conditions used. In some embodiments, the foam quality of the foam compositions of the present disclosure may be inversely proportional to extensional viscosity, such that as extensional viscosity decreases, foam quality increases. Without being bound by theory, it is believed that the lower extensional viscosities exhibit less resistance during extrusion, thereby allowing increased foaming, particularly during the first several seconds.

As an example, typical construction weather seals are generally required to have a water absorption of less than about 10%, particularly those used as automotive seals. The lower the water absorption, the more resistant the material is to the invasion of water (e.g., when exposed to external environmental elements, such as rain, or snow, or automotive fluids, and the like) and thus the longer life and better functionality of the product. If weather seals were to permit substantial water invasion, their use as a seal would be ineffective. The foam compositions of the present disclosure offer superior water absorption values, particularly compared to standard materials used to form such seals, which may have a water absorption closer to the maximum 10% value and/or require a coating to reduce water absorption values.

In one or more embodiments, compared to a thermoplastic vulcanizate material without thermo-expandable microsphere, the foam made from the composition according to the present disclosure may have a reduced density as determined by ISO 1183. For example, the density of the foam composition may be in the range of from about 0.4 grams per cubic centimeter (g/cm³) to about 0.9 g/cm³, or about 0.5 g/cm³ to about 0.9 g/cm³, encompassing any value and subset therebetween. In a preferred embodiment, the foam composition is used to form a seal, such as a weather seal, and the target density is less than about 0.7 g/cm³, or preferably less than about 0.6 g/cm³, such as from about 0.4 g/cm³ to about 0.7 g/cm³ or about 0.4 g/cm³ to about 0.6 g/cm³, encompassing any value and subset therebetween.

In one or more embodiments, a foam made from the composition according to the present disclosure may have suitable ultimate elongation (also referred to as elongation at break) and tensile strength at break as determined by ISO37, such as for use as a construction seal, including a construction weather seal. In some embodiments, the ultimate elongation may be in the range of from about 100% to about 400%, or from about 350% to about 175%, encompassing any value and subset therebetween. The tensile strength at break of the foam compositions described herein may be in the range of about 0.5 megapascal (MPa) to about 4 MPa, or about 1 MPa to about 3 MPa, or about 0.7 MPa to about 3.67 MPa, encompassing any value and subset therebetween.

In one or more embodiments, the foam according to the present disclosure may exhibit a suitable low 100% modulus of elasticity value as determined by ISO 37. For example, the foam may have a 100% modulus in the range of about 0.3 MPa to about 2 MPa, or about 0.4 to about 1.8, encompassing any value and subset therebetween.

In one or more embodiments, the foam according to the present disclosure may exhibit suitable surface roughness as determined by a MITUTOYO™ brand SURFTEST™ SJ-500P Series Roughness Tester available. The surface roughness index (Ri) is a unitless value based on the average roughness (Ra) and the maximum between peak and valley (Rt), where

$$Ri = Ra + ( \frac{1}{10} Rt ) .$$

Generally, rough surfaces wear more readily and have higher friction coefficients compared to smooth surfaces. For example, rough surfaces may have various surface irregularities resulting in potential sites for crack or corrosion formation, particularly when exposed to environmental conditions. Relatively smooth surface roughness may additionally be indicative of closed cell foam structures. Accordingly, relatively low Ri values are preferred, particularly for use in the weather seal applications described herein. The Ri of the foam compositions of the present disclosure may be in the range of about 5 μm to about 30μm, such as from about 5 μm to about 25 μm, or about 6 μm to about 25 μm, encompassing any value and subset therebetween.

As described above, the foam according to the present disclosure is suitable to preparation of a commercial product or article where soft touch is desirable to achieve a seal, such as any construction seal. The seal may encompass any construction seal described hereinabove, including a weather seal (e.g., a door or window seal of a building; a door, window, or trunk seal of an automobile, and the like), and the like, and any combination thereof. Accordingly, in one or more embodiments, the instant disclosure provides a weather seal product or article formed from the foam compositions described herein.

In one or more embodiments, the sealing product or article may be solely made from the foam composition described herein. In other embodiments, or the foam according to the present disclosure may have a surface treatment (or skin layer) applied thereto. The surface treatment may be used to enhance one or more qualities of the seal including, but not limited to, friction reduction, abrasion and wear protection, external environment exposure protection, and, while not needed, additional water absorption reduction. In some embodiments, the surface treatment may be composed of a thermoplastic elastomer, such as a thermoplastic vulcanizate described herein. This layered structure forming a sealing product or article may offer improved functionality to the product or article, without compromising the beneficial properties of the foam composition itself. An example of a suitable material for use as a surface treatment applied to the foam compositions described herein includes SANTOPRENE™ 123-52W242 thermoplastic vulcanizate, available from ExxonMobil Chemicals, Houston, Tex. An alternative example of a surface treatment includes co-extrusion of the foam composition with any other material or material profile, such as a dense material (e.g., dense foam), sponge material, and/or a rigid carrier. The dense or sponge material may provide protection and/or additional sealing capability to a sealing product and the rigid carrier (e.g., a rigid plastic or metal carrier) may be provided to add structure to a sealing product for use in specific commercial applications.

When included, the surface treatment may be applied to the foam compositions of the present disclosure as part of or after the extrusion process, without departing front the scope of the present disclosure. For example, the surface treatment may be sandwich moulded or co-extruded with the foam composition during the extrusion process, or may be applied after the foam is fed through the die of an extruder, such as by painting, spraying, sputtering, or other coating or encapsulation method.

To facilitate a better understanding of the embodiments of the present invention, the following examples of preferred or representative embodiments are given. In no way should the following examples be read to limit, or to define, the scope of the disclosure.

### EXAMPLES

For purposes of convenience, the various specific test procedures used in the examples described hereinbelow are identified in Table 1. It is to be understood that a person of ordinary skill in the art may use various other published or well-recognized test methods to determine a particular property of the foam compositions described herein, without departing from the scope of the present disclosure, although the specifically identified procedures are preferred. Each claim should be construed to cover the results of any of such procedures, even to the extent different procedures may yield different results or measurement values.

TABLE 1

| Property | Testing Method |
|---|---|
| Density | ISO 1183 |
| Water Absorption | ASTM D1056 |
| Shore A Hardness | ISO 868 |
| Ultimate Elongation | ISO 37 |
| Tensile Strength at Break | ISO 37 |
| 100% Modulus | ISO 37 |
| Surface Roughness | SURFTEST ™ SJ-500P Series Tester |

The Examples 1 to 21 are directed to foams made from the composition of present invention. Comparative Example A is directed to a composition comprises microsphere in the absence of TPV, but instead in combination with an elastomer primarily composed of isotactic propylene repeat units with random ethylene distribution. The materials used in the examples are identified as follows:

The thermoplastic vulcanizates: (1) SANTOPRENE™ 101-55. (2) SANTOPRENE™ 121-58W175, (3) SANTOPRENE™ 121-67W175, (4) SANTOPRENE™ 8211-35, (5) SANTOPRENE™ 1221-62M100, (6) SANTOPRENE™ 201-67W171, (7) SANTOPRENE™ 101-80, or (8) SANTOPRENE™ 161-80F260, each available from ExxonMobil Chemicals, Houston, Tex. The nomenclature of each SANTOPRENE™ TPV is based on its product series, color, feature, Shore A or D hardness value, and various application(s). The selected SANTOPRENE™ TPV materials were chosen to encompass a wide range of hardness values and, correspondingly, a wide range of extrusion grades (e.g., melt flow and amount of rubber content). SANTOPRENE™ 101-55 has the highest rubber content of each of the tested SANTOPRENE™ TPVs.

The Shore A hardness (15 sec/23° C.) for each SANTOPRENE™ TPV used in the Examples below is provided in Table 2.

TABLE 2

| SANTOPRENE ™ TPV | Shore A Hardness |
|---|---|
| 101-55 | 60 |
| 121-58W175 | 62 |
| 121-67W175 | 72 |
| 8211-35 | 38 |
| 121-62M100 | 66 |
| 201-67W171 | 71 |
| 101-80 | 87 |
| 161-80F260 | 80 |

The thermo-expandable microspheres: (1) EXPANCEL™ 950MB80 having a Tₛₜₐᵣₜ of 138-148° C. and a Tₘₐₓ of 188-200° C. and (2) EXPANCEL™ 930MB120 having a Tₛₜₐᵣₜ of 122-132° C. and a Tₘₐₓ of 191-204° C., each available from Akzo Nobel N.V. Amsterdam, Netherlands.

The elastomer primarily composed of isotactic propylene repeat units with random ethylene distribution: VISTAMAXX™ 6102, available from ExxonMobil Chemicals, Houston, Tex. The VISTAMAXX™ Comparative A Example, and other Examples including the VISTAMAXX™ elastomer was selected to evaluate the plastic content effect of performance of the various Examples having the foam composition disclosed herein in which it is included. The selected elastomer has a high ethylene content (C2) and a high molecular weight. It is theorized that the addition of the elastomer can increase the amount of plastic phase, which should be beneficial for foaming (e.g, 8211-85).

The formula for each Example is provided in Table 3. Where the symbol “-” is listed, the particular ingredient was not included in the formulation.

TABLE 3

| | SANTOPRENE ™ | EXPANCEL ™ | | VISTAMAXX ™ 6102 |
|---|---|---|---|---|
| Example | TPV | Microsphere | | Elastomer |
| Comp. A | — | 950MB80 | 2.0% | 100% |
| 1 | 101-55 | 950MB80 | 1.5% | — |
| 2 | 121-58W175 | 950MB80 | 1.5% | — |
| 3 | 121-58W175 | 950MB80 | 2.0% | — |
| 4 | 121-58W175 | 950MB80 | 2.5% | — |
| 5 | 121-67W175 | 950MB80 | 1.5% | — |
| 6 | 121-67W175 | 950MB80 | 2.0% | — |
| 7 | 121-67W175 | 950MB80 | 2.5% | — |
| 8 | 8211-35 | 950MB80 | 2.0% | — |
| 9 | 8211-35 | 930MB120 | 2.0% | — |
| 10 | 8211-35 (90%) | 950MB80 | 2.0% | 10% |
| 11 | 8211-35 (90%) | 930MB120 | 2.0% | 10% |
| 12 | 8211-35 (95%) | 950MB80 | 2.0% | 5% |
| 13 | 8211-35 (95%) | 930MB120 | 2.0% | 5% |
| 14 | 121-62M100 | 950MB80 | 1.5% | — |
| 15 | 121-62M100 | 950MB80 | 2.0% | — |
| 16 | 121-62M100 | 950MB80 | 2.5% | — |
| 17 | 201-67W171 | 950MB80 | 1.5% | — |
| 18 | 201-67W171 | 950MB80 | 2.0% | — |
| 19 | 201-67W171 | 950MB80 | 2.5% | — |
| 20 | 101-80 | 950MB80 | 1.5% | — |
| 21 | 161-80F260 | 950MB80 | 1.5% | — |

Each of Comparative Example A and Examples 1-21 were prepared by first drying the TPV (if included) in a desiccant dryer at 80° C. for 3 hours. All components of each formulation were then dry blended in a V-blender for 20 minutes, The formulations were manually fed into a STC Krauss-Maffei Φ45 mm with L/D=32, high shear screw (Barrier flight+Spiral Maddock) extruder. Before each formulation, the barrel of the extruder was purged by that formulation for 10 minutes. Processing conditions are provided in Table 4.

TABLE 4

| Processing Condition | Value | |
|---|---|---|
| Extruder Zone 1 Temperature | 155° | C. |
| Extruder Zone 2 Temperature | 165° | C. |
| Extruder Zone 3 Temperature | 175° | C. |
| Extruder Zone 4 Temperature | 185° | C. |
| Connector Temperature | 180° | C. |
| Die Zone 1 Temperature | 175° | C. |
| Die Zone 2 Temperature | 180° | C. |
| Screw Speed | 60 | RPM |

During processing, the visual qualities of the Examples were observed. Examples 1-21 exhibited suitable surface roughness, moreover, generally the Examples lacking the additional VISTAMAXX™ elastomer had comparably smoother surface, as reiterated in the measurements described hereinbelow. Ease of extrusion was also observed. For example, even at high microsphere content (2.5%) each of 121-58W175 and 121-67W175, as well as 101-55 having a moderate microsphere content (1.5%) were easily extruded. Examples 8-13 comprising SANTOPRENE™ 8211-35 were observed to be weak and/or susceptible to breakage, indicating that the material must be handled carefully during processing.

Density, 100% modulus, tensile strength at break, ultimate elongation, water absorption, and surface roughness index (Ri) were measured by the methods listed in Table 1 for evaluating the physical properties of Comparative Example A and Examples 1-21. The density and tensile strength at break was conducted on the flat portion of omega profile (see FIG. 1). The results are shown as in the Table 5.

TABLE 5

| | | | Tensile | | | |
|---|---|---|---|---|---|---|
| | | | Strength | | | |
| | | 100% | @ | Ultimate | Water | |
| | Density | Modulus | Break | Elongation | absorption | |
| Example | (g/cm³) | (MPa) | (MPa) | (%) | (%) | Ri |
| Comp. A | 0.64 | — | — | — | — | — |
| 1 | 0.88 | 1.68 | 3.67 | 350 | 1.64 | 6.72 |
| 2 | 0.64 | 1.21 | 2.20 | 280 | 1.90 | 6.33 |
| 3 | 0.58 | 1.06 | 1.75 | 252 | 2.11 | 13.31 |
| 4 | 0.52 | 0.94 | 1.43 | 231 | 3.23 | 11.93 |
| 5 | 0.63 | 1.72 | 2.82 | 277 | 3.48 | 10.82 |
| 6 | 0.59 | 1.54 | 2.41 | 264 | 2.67 | 9.55 |
| 7 | 0.53 | 1.35 | 1.96 | 236 | 3.46 | 7.93 |
| 8 | 0.49 | 0.49 | 0.70 | 175 | 1.89 | 24.82 |
| 9 | 0.56 | 0.44 | 0.67 | 186 | 3.23 | 15.84 |
| 10 | 0.53 | 0.48 | 1.01 | 300 | 2.51 | 23.10 |
| 11 | 0.52 | 0.43 | 0.95 | 319 | 2.24 | 19.14 |
| 12 | 0.54 | 0.50 | 0.96 | 252 | 2.07 | 14.41 |
| 13 | 0.51 | 0.43 | 0.77 | 261 | 2.29 | 15.87 |
| 14 | 0.58 | 1.28 | 1.79 | 230 | 1.22 | 18.19 |
| 15 | 0.52 | 1.15 | 1.51 | 236 | 1.77 | 21.41 |
| 16 | 0.47 | 1.03 | 1.28 | 198 | 1.65 | 16.86 |
| 17 | 0.65 | 1.77 | 2.63 | 268 | 0.57 | 7.68 |
| 18 | 0.60 | 1.69 | 2.45 | 259 | 1.04 | 7.42 |
| 19 | 0.51 | 1.32 | 1.69 | 221 | 0.78 | 7.69 |
| 20 | 0.74 | 2.90 | 5.7 | 411 | 0.04 | — |
| 21 | 0.67 | 3.2 | 4.8 | 356 | 0.13 | — |

It can be seen from the testing results that the densities of the foam are substantially low, particularly for use in sealing applications, including weather sealing applications. The tensile strength at break and ultimate elongation are similar to traditional non-microsphere foamed TPV, and exhibit good elastic properties. Further, the water absorption values for each of Examples 1-21 is significantly low, all being less than about 3.5%.

From the density results, W175 and 8211-35 TPV grades have better foam ability than 101-55 TPV grade. It could be explained by rubber content in formulation. Without being bound by theory, and as described above, it is believed that the better foam quality of the W175 and 8211-35 TPV grades may be due to their relatively reduced extensional viscosity compared to 101-55, as shown in FIG. 1. PP content and type additional influences extensional viscosity. Referring to FIG. 1, the W175 grades have an extensional viscosity of about 150,000 Pa·s to about 125,000 Pa·s and 8211-35 grade has an extension viscosity of about 90,000 Pa·s, whereas 101-55 grade has a higher extensional viscosity of about 175,000 Pa·s, each after 5 seconds of applied extensional stress of 0.1 rad/second and at a temperature of 190° C.

Unexpectedly, both 121-58W175 and 121-67W175 (collectively Examples 2-7) exhibited greater foam ability (i.e., lower densities) than 101-55 (Example 1) at all microsphere loading amounts. As provided above, 101-55 has the highest rubber content of the tested SANTOPRENE™ grades, which appears to have a relatively negative impact on foaming ability, even though the foam quality and density of Example 1 is satisfactory. Generally, as melt strength increases, the strength to resist foaming may be stronger resulting in less expansion of the microspheres and relatively higher density. For instance, the melt strength of 8211-35 is low due to high oil content, allowing for good foam ability. Notably, in each of the TPV groupings having 121-58W175 (Examples 2-4), 121-67W175 (Examples 5-7), 121-62M100 (Examples 14-16), and 201-67W171 (Examples 17-19) each generally exhibit decreasing density (and thus foam ability) as the amount of microsphere content increases.

Further referring to the physical properties of the Examples prepared according to one or more embodiments of the present disclosure, each of the 100% modulus, tensile strength at break, and ultimate elongation decrease as density decreases. The correlation of strength and elongation appears to be relatively linear, although the slope of such linear correlation is dependent upon the particular grade of TVP. For example, the harder the TPV material, the severer the change of strength as density decreases. The strength of a particular TPV material may accordingly play a role in foaming, where higher strength limits foam ability and thus, the dosing of foaming agent (e.g., the thermo-expandable microspheres of the present disclosure) has greater impact on dosing. As was the case with density, then, notably, in each of the TPV groupings having 121-58W175 (Examples 2-4), 121-67W175 (Examples 5-7), 121-62M100 (Examples 14-16), and 201-67W171 (Examples 17-19) each generally exhibit decreasing 100% modulus, tensile strength at break, and ultimate elongation as the amount of microsphere content increases.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below, it is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A foam comprising a thermoplastic vulcanizate including an at least partially vulcanized rubber component and a thermoplastic component having a density of about 0.4 grams per cubic centimeter (g/cm³) to about 0.9 g/cm³ and a water absorption of less than about 5% at a pressure of 172 millibar (mbar) below atmosphere.

2. The foam of claim 1, wherein the water absorption is less than about 3.5% at a pressure of 172 millibar (mbar) below atmosphere.

3. The foam of claim 1, wherein the water absorption is less than about 0.7% at a pressure of 172 millibar (mbar) below atmosphere.

4. The foam according of claim 1, wherein the thermoplastic vulcanizate is foamed with a thermo-expandable microsphere foaming agent.

5. The foam of claim 4, wherein the thermo-expandable microsphere foaming agent is present in an amount of about 0.5% to about 5% by weight of the foam.

6. The foam of claim 4, wherein the thermo-expandable microsphere foaming agent has a maximum expansion temperature and the thermoplastic vulcanizate has a melt temperature, both within a temperature range of ±40° C. of each other.

7. The foam of claim 6, wherein the temperature range is ±5° C.

8. The foam of claim 6, wherein the maximum expansion temperature and the melt temperature are about 160° C. to about 240° C.

9. The foam of claim 6, wherein the maximum expansion temperature and the melt temperature are about 170° C. to about 200° C.

10. The foam of claim 1, wherein the foam has a tensile strength at break of about 0.5 megapascal (MPa) to about 4 MPa.

11. The foam of claim 1, wherein the foam has an ultimate elongation of about 100% to about 400%.

12. The foam of claim 1, wherein the thermoplastic vulcanizate has a Shore A hardness of about 35 to about 87.

13. The foam of claim 1, wherein the foam has a surface roughness index (Ri) of about 5 μm to about 30 μm.

14. The foam of claim 1, wherein the foam comprises a surface treatment layer.

15. The foam of claim 1, wherein the at least partially vulcanized rubber is selected from the group consisting of an ethylene-propylene rubber; an ethylene-propylene-diene rubber; a natural rubber; a butyl rubber; a halobutyl rubber; a halogenated rubber copolymer of p-alkystyrene and at least one isomonoolefin having 4 to 7 carbon atoms; a copolymer of isobutylene and divinyl-benzene; a rubber homopolymer of a conjugated diene having from 4 to 8 carbon atoms; a rubber copolymer having at least 50 weight percent repeat units from at least one conjugated diene having from 4 to 8 carbon atoms and a vinyl aromatic monomer having from 8 to 12 carbon atoms, or acrylonitrile monomer, or an alkyl substituted acrylonitrile monomer having from 3 to 8 carbon atoms, or an unsaturated carboxylic acid monomer, or an unsaturated anhydride of a dicarboxylic acid; and any combination thereof.

16. The foam of claim 1, wherein the thermoplastic component is selected from the group consisting of a polymer prepared from olefin monomers having 2 to 7 carbon atoms, a copolymer prepared from olefin monomers having 2 to 7 carbon atoms with a (meth)acrylate or a vinyl acetate, and any combination thereof.

17. The foam of claim 1, wherein the thermoplastic vulcanizate has an extensional viscosity of less than about 200,000 Pa·s after 5 seconds of applied extensional stress of 0.1 rad/second and at a temperature of 190° C.

18. A method for preparation of the foam according to claim 1 comprising:
blending the thermoplastic vulcanizate with a thermo-expandable microsphere foaming agent; and
extruding the blended thermoplastic vulcanizate and the thermo-expandable microsphere foaming agent at an extrusion temperature to form the foam.

19. The method of claim 18, wherein the extrusion temperature is about 160° C. to about 240° C.

20. The method of claim 18, wherein the thermo-expandable microsphere foaming agent has a maximum expansion temperature and the thermoplastic vulcanizate has a melt temperature, both within a temperature range of ±40° C. of each other, and wherein the extrusion temperature, the maximum expansion temperature, and the melt temperature are within the temperature range of ±40° C. of each other.

21. The method according to claim 18, wherein the blending comprises dry blending, melt blending, or hopper blending.

22. The method according to claim 18, further comprising:
applying a surface treatment layer.

23. The method of claim 22, wherein the surface treatment layer is applied by co-extrusion, painting, spraying, or sputtering.

24. A seal comprising the foam of claim 1.

25. The seal of claim 24, wherein the seal is a construction seal.

26. The seal of claim 25, wherein the seal is a door seal, a window seal, or a trunk seal.
